(19) United States
(12) Patent Application Publication
(10) Pub. No.: US 2009/0128440 A1
(43) Pub. Date: May 21, 2009

(54) BALANCED ANTENNA

(75) Inventor: Behzad Tavassoli Hozouri, Santa Clara, CA (US)

Correspondence Address: Patent Venture Group, 10788 Civic Center Drive, Suite 215, Rancho Cucamonga, CA, 91730-3805, US

(73) Assignee: X-ETHER, INC., Santa Clara, CA (US)

(21) Appl. No.: 12/273,369

(22) Filed: Nov. 18, 2008

Related U.S. Application Data
(60) Provisional application No. 60/988,868, filed on Nov. 19, 2007.

(51) Int. Cl. H01Q 9/16; H01Q 1/50

(52) U.S. Cl. 343/821

(57) ABSTRACT

An antenna. A base body made of a dielectric material is provide, wherein the base body has a bottom surface and an opposed top surface. A conductive layer of a conductive material is provided on the bottom surface of the base body. Two dipole conductors are provided that form a dipole on the top surface of the base body, wherein the dipole conductors are at least partially spiral shaped and have opposite directions. A balun is provided that has a feed conductor section and two ground conductor sections that are all substantially parallel. The balun receives an unbalanced signal from a feed line, transforms this signal, and provides it to the dipole conductors via the feed and ground conductor sections.

### CROSS-REFERENCE TO RELATED APPLICATIONS

This application claims the benefit of U.S. Provisional Application No. 60/988,868, filed Nov. 19, 2007, hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to radio wave communications, and more particularly to balance-fed antennas for use in such communications.

2. Background Art

For many communication networks today, particularly ones for mobile type applications, some primary antenna requirements are a compact structure, wide beam coverage, and efficiency over a specific bandwidth. Some examples of common devices currently used in such communications networks include cellular telephone handsets and GPS (global positioning system) user equipment. Another important requirement here is often isolation between the antenna and its surrounding environment, to help minimize detuning of the antenna. For instance, such an environment may include a platform to which the antenna is attached or the body of a person holding a device that the antenna is part of, and what may or may not be present in such an environment often cannot be known and taken into account when an antenna is being designed and manufactured.

Various prior art antenna types have been tried to meet the above-mentioned requirements. One such type is the patch antenna. These usually provide a low enough profile, but often do not provide adequate isolation and thus are subject to detuning. Another such candidate type is the quadrifilar helical antenna (QFH). But these typically do not provide an inherently low profile, and hence may require substantial miniaturization efforts. Mass production of such prior art antennas, particularly when loaded with dielectric material, e.g., a ceramic, is also usually neither easy nor performed at low cost.

It accordingly follows that there remains a need for improved antennas, especially in applications such as mobile communications.

### BRIEF SUMMARY OF THE INVENTION

In view of the present state of the art of the art and the limitations thereof, it is a general object of this invention to provide an improved antenna, particularly for mobile communication applications.

Briefly, one preferred embodiment of the present invention is an antenna. A base body is provided that is made of a dielectric material and has a bottom surface and an opposed top surface. A conductive layer of a conductive material is provided on the bottom surface of the base body. Two dipole conductors are provided that form a dipole on the top surface of the base body. These dipole conductors are at least partially spiral shaped and spiral in opposite directions. A balun is provided that has a feed conductor section and two ground conductor sections that are all substantially parallel. The balun is used to receive an unbalanced signal from a feed line, to transform that signal, and to provide that signal to the dipole conductors via the feed and ground conductor sections.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a top-front perspective view of a first preferred embodiment of an antenna in accord with the present invention, here showing major features and with hidden lines of these shown in ghost format.

FIG. 2 is the same view of the antenna as FIG. 1, but with the hidden lines removed and references added.

FIG. 3 is a bottom-rear perspective view with a section (nominally taken along section A-A in FIG. 2) partially removed here to better illustrate internal features of the antenna.

FIG. 4 is a side cross section view of the antenna taken along section A-A in FIG. 2.

FIG. 5 is a side cross section view similar to FIG. 4, except showing two optional variations of the antenna in FIGS. 1-4.

FIG. 6 is a top-front perspective view of a second preferred embodiment of an antenna in accord with the present invention, here showing major features and with hidden lines of these shown in ghost format.

FIG. 7 is the same view of the antenna as FIG. 6, but with the hidden lines removed and references added.

FIG. 8 is a bottom-rear perspective view with a section (nominally taken along section B-B in FIG. 7) partially removed here to better illustrate internal features of the antenna.

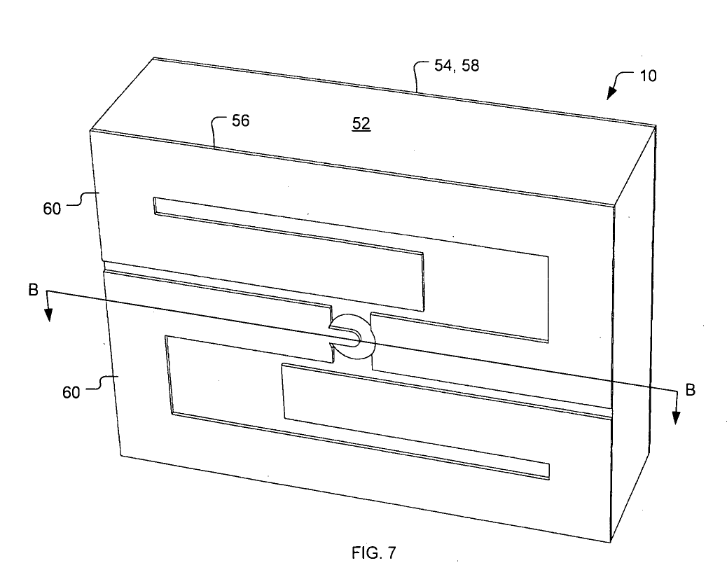

And FIG. 9 is a side cross section view of the antenna taken along section B-B in FIG. 7.

In the various figures of the drawings, like references are used to denote like or similar elements or steps.

### DETAILED DESCRIPTION OF THE INVENTION

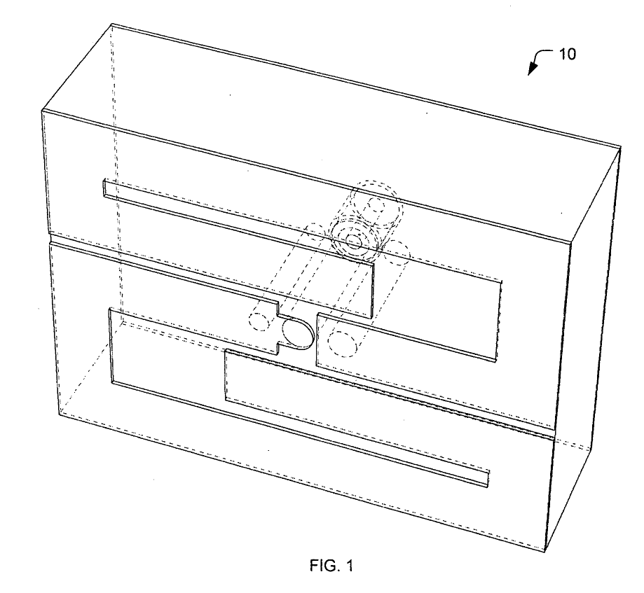

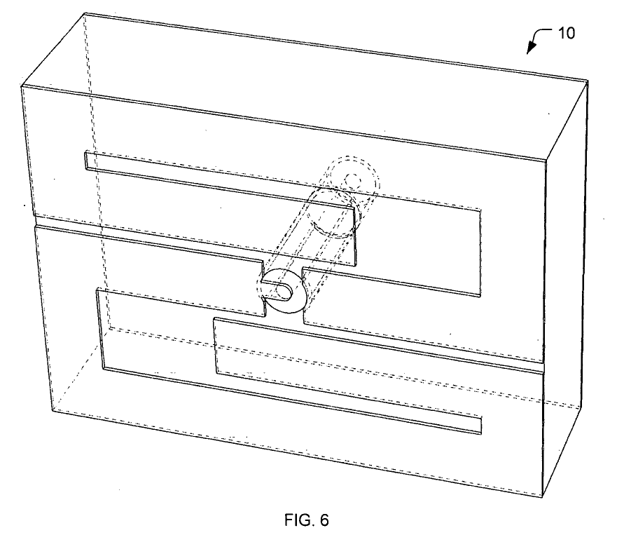

A preferred embodiment of the present invention is balanced antenna. As illustrated in the various drawings herein, and particularly in the views of FIGS. 1 and 6, preferred embodiments of the invention are depicted by the general reference character 10.

Briefly, all the aforementioned objects for the inventive antenna 10 are accomplished by utilizing balance-fed and, at least partially, spiral shaped radiating elements in the antenna 10. Although the figures depict the antenna 10 as having a generally rectangular overall shape, alternate embodiments may be square or generally elliptical (including circular) in shape.

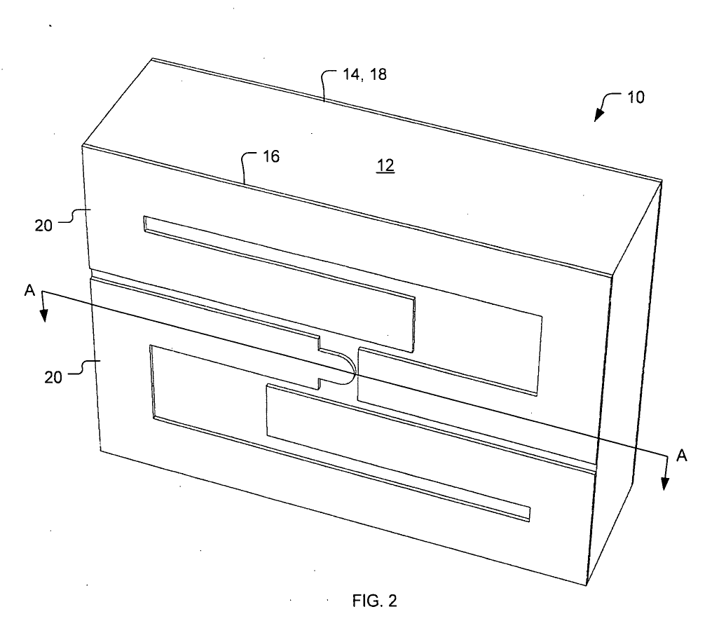

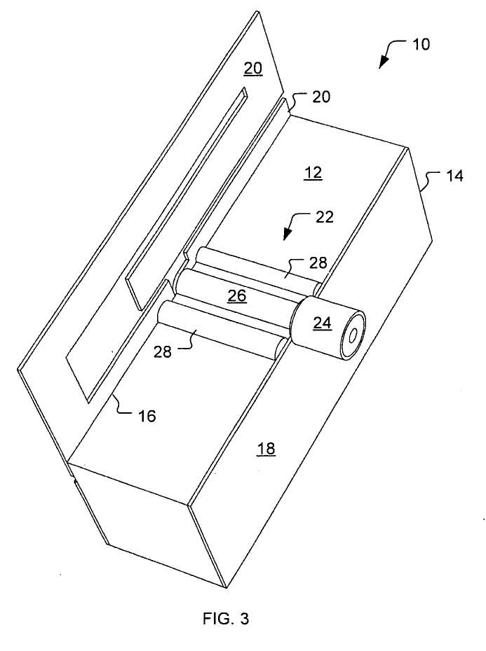

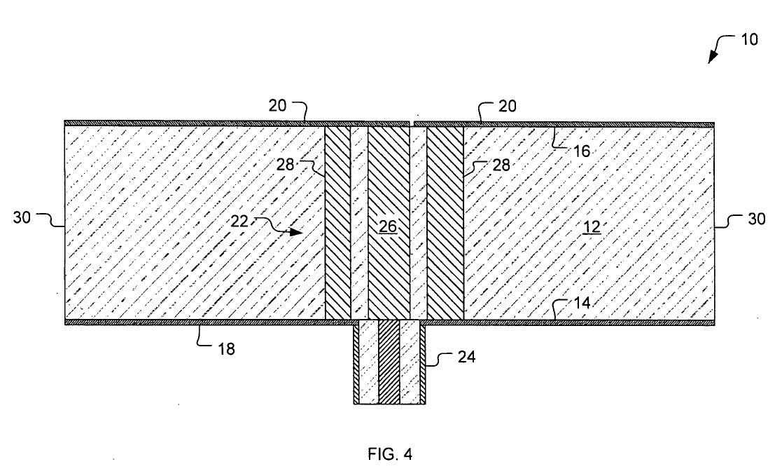

FIGS. 1-4 depict a first preferred embodiment of the inventive antenna 10. FIG. 1 is a top-front perspective view of the antenna 10 that shows major features, with hidden lines shown in ghost format. FIG. 2 is the same view of the antenna 10 as FIG. 1, but with the hidden lines removed and references added. FIG. 3 is a bottom-rear perspective view with a section (nominally taken along section A-A in FIG. 2) partially removed here to better illustrate internal features of the antenna 10. And FIG. 4 is a side cross section view of the antenna 10 taken along section A-A in FIG. 2.

Turning now to FIG. 2, the antenna 10 has a base body 12 which is made of a material preferably having a high dielectric constant, e.g., greater than 4. Although the base body 12 of the antenna 10 is shown here as planar, this is not a requirement and it can conform to a platform (not shown) that the antenna 10 is mounted on. For instance, the base body 12 can be curved.

The base body 12 of the antenna 10 particularly has a bottom surface 14 and a top surface 16. The bottom surface 14 has a conductive layer 18 of a conductive material, e.g., a coating or covering of copper. This conductive layer 18 typically extends across all of the bottom surface 14 except for a small feed area for a feed line connection to the antenna 10 (see e.g., FIG. 4). On the top surface 16 of the antenna 10 there are two similar conductor sections which form a dipole, hereinafter called dipole conductors 20. These dipole conductors 20 are preferably printed on the top surface 16 and are spiral or partially spiral shaped with opposite directions. It has been observed by the inventor that such a shape not only reduces the size of the antenna 10, but also increases the radiation efficiency compared to many other known shapes. In other words, the spiral or partial spiral shape can be optimized for maximum radiation efficiency.

Turning now also to FIG. 3, in order for the inventive antenna 10 to have high electrical performance and radiating efficiency, the dipole conductors 20 are fed with signals having equal amplitude but with a phase difference of 180 degrees, i.e., they should be balance fed. Therefore at the center of the antenna 10, a balanced feed assembly is provided, i.e., a balun 22. This balun 22 then transforms unbalanced signals from a feed line 24 (here a conventional coaxial line having an central conductor, outer conductor, and separating dielectric) to balanced form for exciting the dipole conductors 20.

The balun 22 comprises three conductors extending through the base body 12 of the antenna 10. These can have different dimensions and shapes, and these can be of different shape among the three of them. In particular, these can be strips or posts (as shown particularly in FIG. 3). The first conductor is a feed strip/post 26 which is directly connected to the central conductor of the coaxial feed line 24 and also to one of the dipole conductors 20. The two other strips/posts, hereinafter called ground strips/posts 28, are substantially parallel to the feed strip/post 26 and are each connected to one dipole conductor 20 and to the conductive layer 18 at the bottom surface 14 of the antenna 10. One of the dipole conductors 20 is thus connected to both the feed strip/post 26 and one of the ground strips/posts 28, and the other dipole conductors 20 is connected to the other ground strip/post 28. It is another observation by the inventor that using different sizes for the ground strips/posts 28 may help improve the electrical performance of the balun 22. This performance can also depend on various other parameters, including the dielectric constant and the thickness of the base body 12 of the antenna 10.

FIG. 4 is an alternate view that more clearly shows some of the feature just discussed. Here the connections of the dipole conductors 20 and the feed line 24 to the strips/posts 26, 28 can be more easily seen, with the area of the bottom surface 14 that does not have the conductive layer 18 is particularly visible. The use of different dimensions for the two ground strips/posts 28 is also particularly visible here.

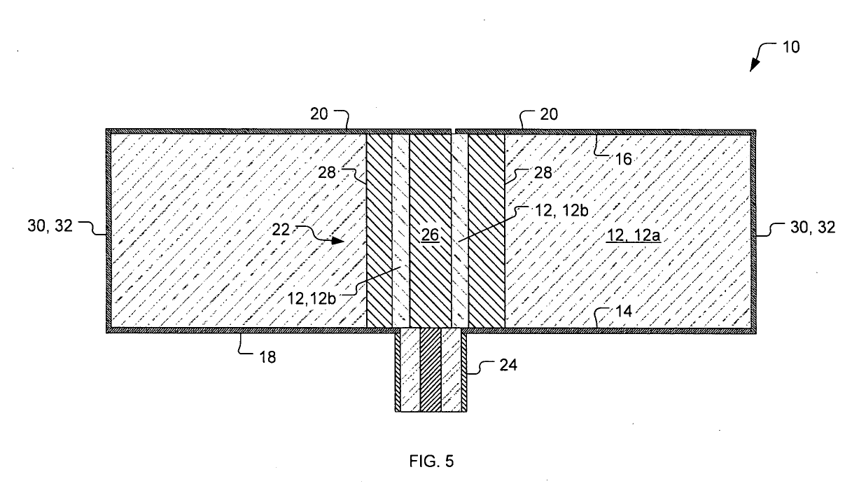

FIG. 5 is a side cross section view similar to FIG. 4, except showing two optional variations of the antenna 10. In embodiments of the inventive antenna 10 it is optional to use a dielectric material that is either the same as or different from the one which the base body 12 of the antenna 10 is made of, between the feed strip/post 26 and the two ground strips/posts 28. In FIG. 5 this is shown as a first dielectric material 12a and a second dielectric material 12b. Between the bottom surface 14 and the top surface 16 the base body 12 of the antenna 10 may also have sidewalls 30 that are completely or partially covered with a conductive coating 32 (or layer). Whether this is done may depend on the dielectric material of the base body 12 is made of. Particularly for materials having a very high dielectric constant, e.g., greater than 70, using an uncovered sidewalls 30, i.e., non-metalized ones, may provide better electrical performance for the balun 22 and/or the total antenna 10.

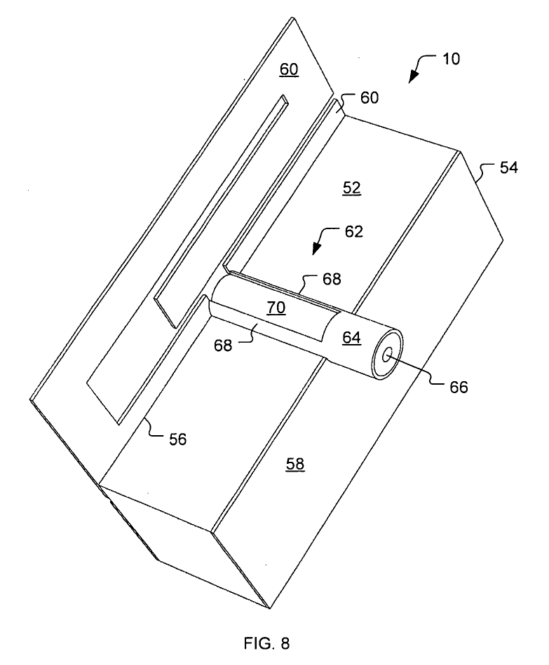

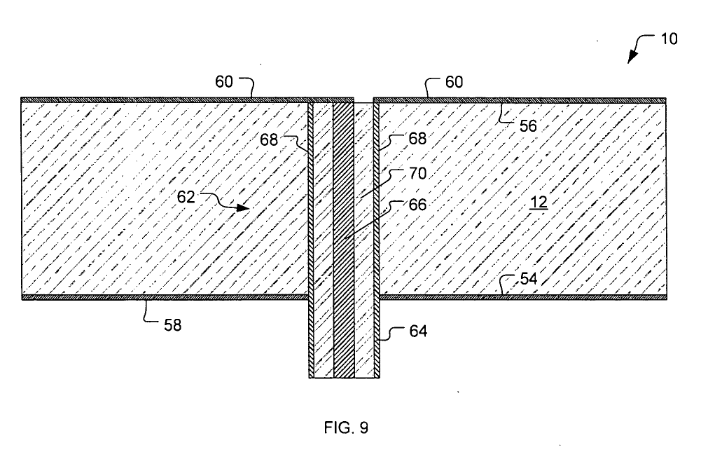

FIGS. 6-9 depict a second preferred embodiment of the inventive antenna 10. FIG. 6 is a top-front perspective view of the antenna 10 that shows major features, with hidden lines shown in ghost format. FIG. 7 is the same view of the antenna 10 as FIG. 6, but with the hidden lines removed and references added. FIG. 8 is a bottom-rear perspective view with a section (nominally taken along section B-B in FIG. 7) partially removed here to better illustrate internal features of the antenna 10. And FIG. 9 is a side cross section view of the antenna 10 taken along section B-B in FIG. 7. In this embodiment the central conductor and the dielectric material of the feeding coaxial line extension are used as parts of the balun, hence facilitating manufacturing of the antenna 10.

Turing now to FIG. 7, the embodiment of the antenna 10 here has a base body 52 that particularly has a bottom surface 54 and a top surface 56. The bottom surface 54 has a conductive layer 58 of a conductive material that typically extends across all of the bottom surface 54 except for a small area for a feed line connection (see e.g., FIG. 9). On the top surface 56 of the antenna 10 there are two similar dipole conductors 60 that are spiral or partially spiral shaped with opposite directions.

Turning also to FIG. 8, it can be seen that the antenna 10 has a balun 62 and is fed with a feed line 64. The balun 62 has three conductor sections that extend through the base body 52 of the antenna 10. Unlike the embodiments of the inventive antenna 10 in FIGS. 1-5, where the conductors of the balun 22 are substantially discrete elements, the conductor sections of the balun 62 here are essentially integral portions of the feed line 64. The feed line 64 has a central conductor that becomes a feed conductor section 66 that extends through the base body 52 and connects to one of the dipole conductors 60. The feed line 64 further has an outer conductor which becomes two ground conductor sections 68 that also extend through the base body 52. These two ground conductor sections 68 can be formed by splitting (or partially removing) portions of the outer conductor of the feed line 64. One of these ground conductor sections 68 is connected to the same dipole conductor 60 that the feed conductor section 66 connects to and the other ground conductor section 68 is connected to the other dipole conductor 60. Although other approaches can be also used, the separating dielectric of the feed line 64 here in this embodiment is used as a second dielectric material 70 (distinct from the first dielectric material of the base body 52).

Turning next to some general considerations that apply to all embodiments of the inventive antenna 10, those skilled in the art will appreciate that the terms “radiate” and “excite” can be used to refer to the antenna 10 for both transmitting and receiving signals. The electrical characteristics of the antenna 10, such as its frequency response and radiation pattern, will obey the reciprocity rule, i.e., these will be the same when transmitting and receiving signals.

Although the balun 22, 62 and the dipole conductors 20, 60 can be designed and fine-tuned substantially separately, it should also be noted that it is also possible to design the total structure of the antenna 10 together so that the possible interactions between its various elements are considered.

Since the impedance seen by the feed line 24, 64 is not necessarily equal to its characteristic impedance, e.g., 50 Ohms, it typically will be necessary to provide impedance matching through some mechanism. Prior art approaches exist which can be employed for this. For example, a quarter wavelength circuit can be employed or a general matching circuit comprising a capacitor and an inductor at the feed point can be used, preferably one located at the bottom surface 14, 54 of the antenna 10.

If desired, known miniaturization techniques, including dielectric loading and meandering the radiating conductors can be utilized to reduce the size of the inventive antenna 10. The bandwidth of the antenna 10 can also be increased by using specific shapes, known in the art, for the dipole conductors 20, 60, such as tapering their width.

Many other prior art devices and features can also be utilized in connection with the inventive antenna 10 here to provide further benefits and improvements in electrical and electromagnetic performance. These may, however, require compromises in some other respects. For example, a choke (e.g., of radial type) can be placed at or attached to the bottom surface 14, 54 to further increase isolation between the antenna 10 and a platform on which it is installed. Such a choke will, however, then increase the total height/thickness of the antenna 10.

The inventive antenna 10 provides many notable advantages. Since it can particularly utilize materials having high dielectric constants, e.g. more than 4, and it has a balance structure, the near field can be constrained and the antenna 10 can be highly tolerant to the proximity of people, other components, and other antennas. Using material with high dielectric constant also helps shrink the size of the antenna 10, while maintaining high radiation efficiency. This also helps the antenna 10 to have a very sharp filtering response, and hence reduce the need for additional filtering between the antenna 10 and a receiver and/or transmitter. As the antenna 10 is balanced, it prevents common mode noise from entering a receiver through the antenna path. The antenna 10 can also provide the advantages of low profile, light weight, low manufacturing cost, substantial isolation from a platform, and wide beam coverage.

While various embodiments have been described above, it should be understood that they have been presented by way of example only, and that the breadth and scope of the invention should not be limited by any of the above described exemplary embodiments, but should instead be defined only in accordance with the following claims and their equivalents.

1. An antenna comprising:
a base body made of a dielectric material, wherein said base body has a bottom surface and an opposed top surface;
a conductive layer of a conductive material on said bottom surface of said base body;
two dipole conductors that form a dipole on said top surface of said base body, wherein said dipole conductors are at least partially spiral shaped and have opposite directions; and
a balun having a feed conductor section and two ground conductor sections that are all substantially parallel, said balun to receive an unbalanced signal from a feed line, to transform said signal, and to provide said signal to said dipole conductors via said feed conductor section and said ground conductor sections.

2. The antenna of claim 1, wherein said dielectric material of said base body has a dielectric constant greater than 4.

3. The antenna of claim 1, wherein said base body has rectangular or elliptical shape.

4. The antenna of claim 1, wherein said conductive layer extends across all of said bottom surface except for an area at said feed line.

5. The antenna of claim 1, wherein said conductive layer and said dipole conductors are nominally planar and said conductive layer is opposed in parallel to said dipole conductors.

6. The antenna of claim 1, wherein said dipole conductors are printed onto said base body.

7. The antenna of claim 1, wherein said feed conductor section of said balun is a strip or post extending from a coaxially central conductor of said feed line to one said dipole conductor.

8. The antenna of claim 1, wherein said feed conductor section of said balun is a coaxially central conductor of said feed line.

9. The antenna of claim 1, wherein a coaxially outer conductor of said feed line connects to said conductive layer and said ground conductor sections of said balun are strips or posts each extending from said conductive layer to a respective said dipole conductor.

10. The antenna of claim 1, wherein said feed conductor section of said balun is a coaxially central conductor of said feed line.

11. The antenna of claim 1, wherein said ground conductor sections of said balun are sub-sections of an outer conductor of said feed line.

12. The antenna of claim 1, wherein said ground conductor sections of said balun have different shapes.

13. The antenna of claim 1, wherein said ground conductor sections of said balun have different distance from said feed conductor section of said balun.

14. The antenna of claim 1, wherein said dielectric material of said base body is a first dielectric material and between said feed conductor section and said ground conductor sections of said balun is a second dielectric material having a different dielectric constant than said first dielectric material.

15. The antenna of claim 14, wherein said second dielectric material is a same material as a separating dielectric in said feed line.

16. The antenna of claim 1, wherein said base body further has a side wall or walls of a conductive coating extending between said bottom surface and said top surface.

17. The antenna of claim 1, wherein said dielectric material of said base body defines a non-conductive side wall or walls extending between said bottom surface and said top surface.
